(19) United States
(12) Patent Application Publication
(10) Pub. No.: US 2025/0377889 A1
(43) Pub. Date: Dec. 11, 2025

(54) VECTOR PROCESSOR AND METHOD OF EXECUTING ARITHMETIC OPERATION IN VECTOR PROCESSOR

(71) Applicant: Fujitsu Limited, Kawasaki-shi (JP)

(72) Inventors: Sota SAKASHITA, Kawasaki (JP); Ryohei OKAZAKI, Kawasaki (JP); Chunye YOU, Kawasaki (JP)

(73) Assignee: Fujitsu Limited, Kawasaki-shi (JP)

(21) Appl. No.: 19/229,630

(22) Filed: Jun. 5, 2025

(30) Foreign Application Priority Data
Jun. 11, 2024 (JP) 2024-094152

(51) Int. Cl. G06F 9/30

(52) U.S. Cl. CPC G06F 9/30038; G06F 9/3001; G06F 9/3016

(57) ABSTRACT

A vector processor includes a mask register configured to hold mask values, an instruction decoder configured to set dependency information included in instruction execution information when a decoded instruction is a subsequent instruction having data dependency with one or more previous instructions, and to set all-set information included in instruction execution information when a decoded instruction sets all of the mask values, a vector processing unit configured to execute vector arithmetic operations based on the instruction execution information, and to store in the data register a result of an arithmetic operation of a vector element corresponding to each mask value that is in a set state, and a dependency reset unit configured to reset the dependency information corresponding to a destination operand of the subsequent instruction and the mask register, when the all-set information is set for the mask register and the mask register is designated by the subsequent instruction.

### CROSS-REFERENCE TO RELATED APPLICATIONS

The present application is based upon and claims the benefit of priority from the prior Japanese Patent Application No. 2024-094152 filed on Jun. 11, 2024, with the Japanese Patent Office, the entire contents of which are incorporated herein by reference.

### FIELD

The disclosures herein relate to vector processors and methods of executing arithmetic operations in a vector processor.

### BACKGROUND

In a vector processor capable of executing arithmetic operations for each element of vector data, for example, each mask value stored in a mask register is used to determine whether to store the resultant data of an arithmetic operation in a destination register for a corresponding element of the vector data. For example, when a mask value is set, the resultant data of an arithmetic operation is stored in a corresponding element of the destination register, and when the mask value is reset, the data already held in this element of the destination register is stored. That is, mask values are used to perform a merge process that stores the resultant data of arithmetic operations or the data already held in the destination register on an element-by-element basis. In this type of vector processor, execution of a subsequent instruction having data dependency with the previous instruction is delayed until the data dependency is eliminated (see, for example, Japanese Laid-open Patent Publication No. 2019-086809).

When all mask values in the mask register are set, only the resultant data of arithmetic operations are stored in the destination register. It is thus unnecessary to merge the resultant data of arithmetic operations with data (i.e., merging sources) already held in the destination register. However, the need to merge the resultant data of arithmetic operations and the merging sources is not known until the mask values are read from the mask register.

A scheduler which controls the issuance of an instruction to an arithmetic unit starts execution of the subsequent instruction by aligning the start timing with the storing of the merging source of the previous instruction in the register. In the case in which a vector processor is capable of executing the all-set instruction for setting all mask values of the mask register, the scheduler starts execution of the subsequent instruction using the mask register by aligning the start timing with the setting of all the mask values in the mask register. This arrangement may delay the execution of the subsequent instruction, which lowers the processing performance of the vector processor.

### SUMMARY

According to an aspect of the embodiment, a vector processor for executing vector arithmetic operations includes a mask register configured to hold mask values set for respective vector elements when calculation results of the vector elements are stored in a data register, an instruction decoder configured to decode each instruction to generate instruction execution information for each decoded instruction, to set dependency information included in the instruction execution information when a decoded instruction is a subsequent instruction having data dependency with one or more previous instructions, and to set all-set information included in the instruction execution information when a decoded instruction is an all-set instruction for setting all of the mask values of the mask register, a scheduler configured to hold the instruction execution information for each decoded instruction and to sequentially output the instruction execution information for instruction each whose data dependency has been eliminated based on the dependency information included in the held instruction execution information, a vector processing unit configured to execute vector arithmetic operations for respective vector elements based on the instruction execution information output from the scheduler, and to store in the data register a result of an arithmetic operation of a vector element corresponding to each mask value that is in a set state and held in the mask register, and a reset unit configured to reset dependency the dependency information corresponding to a destination operand of the subsequent instruction and the dependency information corresponding to the mask register transferred from the instruction decoder to the scheduler, when the all-set information is set for the mask register and the mask register is designated by the subsequent instruction.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a vector processor according to an embodiment;

FIG. 2 is a drawing illustrating an example of merging data of a destination register according to the stored values of a mask register at the time of executing the addition instruction illustrated in FIG. 1;

FIG. 3 is a drawing illustrating examples of operations in which the vector processor illustrated in FIG. 1 and a comparative vector processor execute the addition instruction illustrated in FIG. 2;

FIG. 4 is a drawing illustrating an example of a pipeline operation of the comparative vector processor not having the dependency reset unit illustrated in FIG. 1;

FIG. 5 is a drawing illustrating an example of a pipeline operation of the vector processor illustrated in FIG. 1;

FIG. 6 is a block diagram illustrating an example of a vector processor according to another embodiment;

FIG. 7 is a drawing illustrating an example of the register renaming unit illustrated in FIG. 6;

FIG. 8 is a drawing illustrating an example of a pipeline operation of the vector processor illustrated in FIG. 6.

FIG. 9 is a drawing illustrating an example of the circuit and functioning of the dependency reset unit illustrated in FIG. 6;

FIG. 10 is a drawing illustrating an example of a process of resetting a dependency flag by the dependency reset unit in the D-cycle of the addition instruction ADD illustrated in FIG. 9; and

FIG. 11 is a block diagram illustrating an example of an information processing system including the vector processor illustrated in FIG. 1 or FIG. 6.

### DESCRIPTION OF EMBODIMENTS

In the following, embodiments of the present invention will be described with reference to the accompanying drawings.

In the following, embodiments will be described with reference to the accompanying drawings. Hereinafter, the same reference characters as the name of a signal is used for a signal line for transmitting the signal. Although not specifically restricted, the vector processor described below is a superscalar processor and executes instructions in parallel by pipeline processing. The vector processor described below may be a scalar processor.

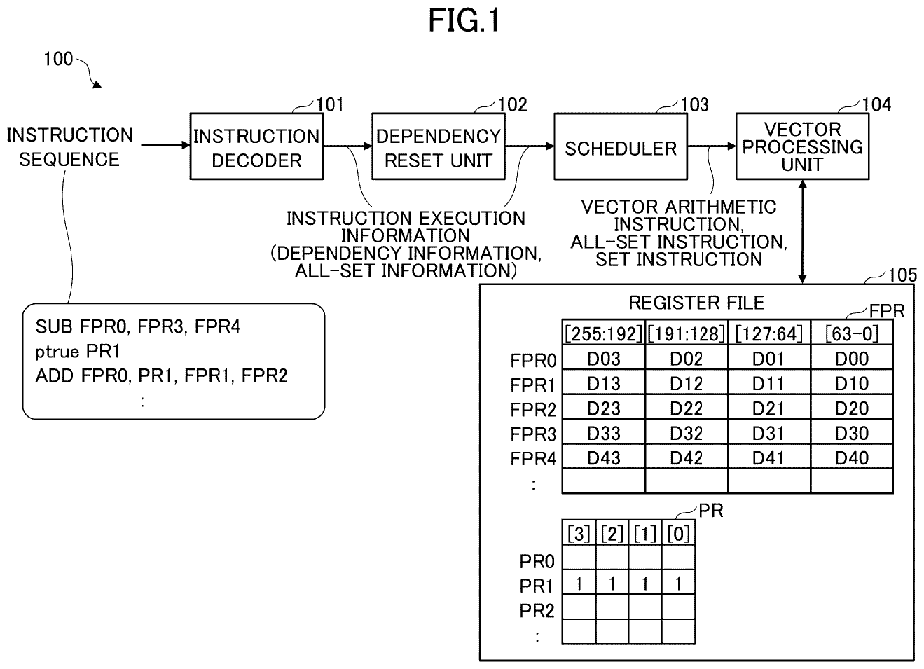

FIG. 1 illustrates an example of a vector processor in one embodiment. A vector processor 100 illustrated in FIG. 1 includes an instruction decoder 101, a dependency reset unit 102, a scheduler 103, a vector processing unit 104, and a register file 105.

The register file 105 includes a plurality of registers FPR (FPR0, FPR1, FPR2, FPR3, FPR4, . . . ) for holding data and a plurality of mask registers PR (PR0, PR1, PR2, . . . ) for holding mask values. The registers FPR are an example of data registers.

For example, each register FPR is 256 bits wide and configured to hold 4 elements (i.e., data) of 64-bit floating-point numbers included in vector data. In FIG. 1, four 64-bit elements held in each register FPR are indicated as data D00, D01, D02, and D03, or the like. The description below is directed to an example of computing floating-point data using the registers FPR for floating-point numbers, but may as well be applicable to the computing of fixed-point data using the register FPR for fixed-point numbers. In this case, the vector processor 100 includes mask registers for fixed-point numbers.

Each mask register PR has, for example, a width of 4 bits and is configured to hold four 1-bit mask values in one-to-one correspondence with the four elements of a corresponding one of the registers FPR. The mask value “0” indicates that the data (i.e., merging source) already held in the register FPR (i.e., destination register) for storing the resultant data of an arithmetic operation of the subsequent instruction is retained without being rewritten with the resultant data of the arithmetic operation. The mask value “1” indicates that the data already held in the register FPR (destination register) for storing the data resultant of the arithmetic operation of the subsequent instruction is rewritten with the resultant data of the arithmetic operation.

The size of the register FPR is not limited to 256 bits, and the number of elements of the register FPR is not limited to 4. Further, the number of elements of the register FPR may vary, achieving configurations such as 64 bits×4, 32 bits×8, and 16 bits×16. When the number of elements of register FPR is variable, the number of elements of the mask register PR is made to vary according to the number of elements of register FPR. Because of this, the mask register PR is designed to be 32 bits width when the maximum number of elements of the register FPR is 32. Among the 32 bits of the mask register PR, the same number of bits as the number of elements of register FPR are selectively used to hold mask values.

The instruction decoder 101 decodes an instruction included in the instruction sequence and outputs the result of decoding as instruction execution information to the scheduler 103 via the dependency reset unit 102. FIG. 1 illustrates an example in which a subtraction instruction SUB, an all-set instruction ptrue, and an addition instruction ADD are sequentially supplied to the instruction decoder 101. In the following, a subtraction instruction SUB, an all-set instruction ptrue, and an addition instruction ADD are also referred to as a SUB instruction, a ptrue instruction, and an ADD instruction, respectively.

In FIG. 1, the SUB instruction performs an element-wise subtraction of the vector data held in the register FPR4 from the vector data held in the register FPR3, and stores the result of subtraction for each element in the register FPR0 (i.e., destination register). Each element of the mask register PR1 is set to “1” by the ptrue instruction. The ADD command adds the vector data held in the register FPR1 and the vector data held in the register FPR2 on an element-by-element basis, and stores the results of addition in the register FPR0 (i.e., destination register) according to the mask values of the mask register PR1. Since all the mask values of the mask register PR1 become “1” by the ptrue command, all the resultant elements of addition are stored in the register FPR0.

The register FPR0 which stores the results of subtraction is the same as the register FPR0 which stores the results of addition by the ADD command. In the case in which the ptrue command is not executed, thus, the results of subtraction or the results of addition are selectively retained according to the element-specific mask values of the mask register PR1. Therefore, the timing of storing the addition results in the register FPR0 must be set later than the timing of storing the subtraction results in the register FPR0. The register FPR0 shared by the SUB command and the ADD command has RAW (Read After Write) data dependency.

Upon decoding the all-set instruction ptrue for the mask register PR1, the instruction decoder 101 sets the all-set information for the mask register PR1 to “1” in the instruction execution information of the all-set instruction ptrue, and outputs the instruction execution information to the dependency reset unit 102. Upon detecting the RAW data dependency regarding the destination register FPR0 by decoding the ADD command, the instruction decoder 101 sets the dependency information about the register FPR0 to “1” in the instruction execution information of the ADD command. The instruction decoder 101 outputs the instruction execution information in which the dependency information about the register FPR0 is set to “1” to the dependency reset unit 102.

In the instruction sequence illustrated in FIG. 1, all-set information is set for the mask register PR1, which is to be specified by the subsequent ADD instruction, and the dependency information about the destination register FPR0 used by the subsequent ADD instruction is also set. In this case, the dependency reset unit 102 resets the dependency information about the mask register PR1 and the dependency information about the destination register FPR0 used by the subsequent ADD instruction to “0” for output to the scheduler 103.

When all-set information is not set for the mask register PR which is to be specified by the subsequent instruction and the dependency information about the destination register FPR used by the subsequent instruction is set, the dependency reset unit 102 outputs the dependency information to the scheduler 103 without resetting it. That is, when the all-set instruction ptrue is not executed, the dependency reset unit 102 outputs the instruction execution information of the subsequent instruction received from the instruction decoder 101 to the scheduler 103 as it is. For example, the instruction decoder 101 is equipped to decode a mask-set instruction that individually sets the mask values of the mask register PR.

If all-set information is set for the mask register PR specified by the subsequent instruction and the dependency information about the destination register FPR used by the subsequent instruction is not set, the dependency reset unit 102 outputs the instruction execution information of the subsequent instruction received from the instruction decoder 101 to the scheduler 103 as it is. That is, when the all-set instruction ptrue is executed for the mask register PR specified by the subsequent instruction for which the dependency information about the destination register FPR is not set, the dependency reset unit 102 outputs the instruction execution information of the subsequent instruction received from the instruction decoder 101 to the scheduler 103 as it is.

The scheduler 103 sequentially holds instruction execution information (i.e., with respect to vector arithmetic instructions, all set instructions, etc.) received via the dependency reset 102. Based on the dependency information unit included in the instruction execution information held therein, the scheduler 103 sequentially outputs instruction execution information of instructions whose data dependency has been eliminated to the vector processing unit 104 (in out-of-order). Note that the scheduler 103 may be provided to correspond to a vector processing unit and a mask processing unit described below.

The vector processing unit 104 includes vector processing units and a mask processing unit. Upon receiving the instruction execution information of a vector arithmetic instruction (e.g., SUB instruction, ADD instruction, or the like) from the scheduler 103, the vector processing units read data from the source register FPR, execute the vector arithmetic instruction, and store the results of execution in the destination register FPR.

Upon receiving the instruction execution information of an all-set instruction ptrue from the scheduler 103, the mask processing unit sets all the mask values of the mask register PR to “1”. Upon receiving the instruction execution information of a mask-set instruction from the scheduler 103, the mask processing unit sets each mask value of the mask register PR to “1” or “0” according to the instruction execution information.

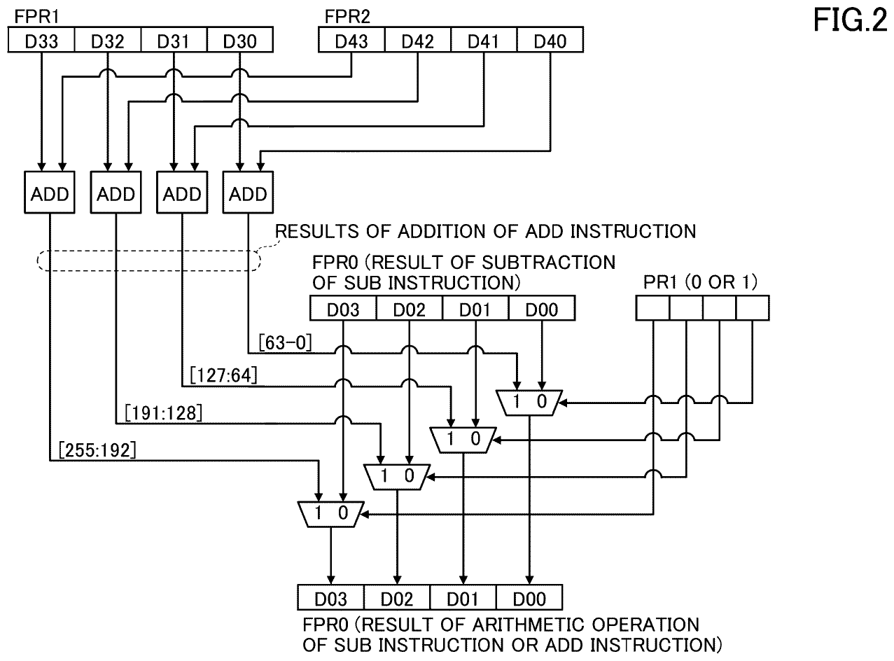

FIG. 2 illustrates an example of merging data in the destination register FPR0 according to the stored values of the mask register PR1 at the the addition ADD time of executing instruction illustrated in FIG. 1. The vector processing units indicated by the symbol “ADD” add data stored in the source registers FPR1 and FPR2 on an element-by-element basis, and output the results of addition.

When the mask value “1” is stored in an element of the mask register PR1, the vector processing unit selects the result of addition of the corresponding element, and stores it in the destination register FPR0. When the mask value “O” is stored in an element of the mask register PR1, the vector processing unit selects the corresponding element of the results of arithmetic operations for the previous instruction (the results of subtraction in this example), and stores it in the destination register FPR0.

In this manner, the addition instruction by the vector processing unit not only adds data, but also reads the mask values held in the mask register PR1, reads the results of arithmetic operations of the previous instruction, and selects the elements to be stored in the destination register FPR0.

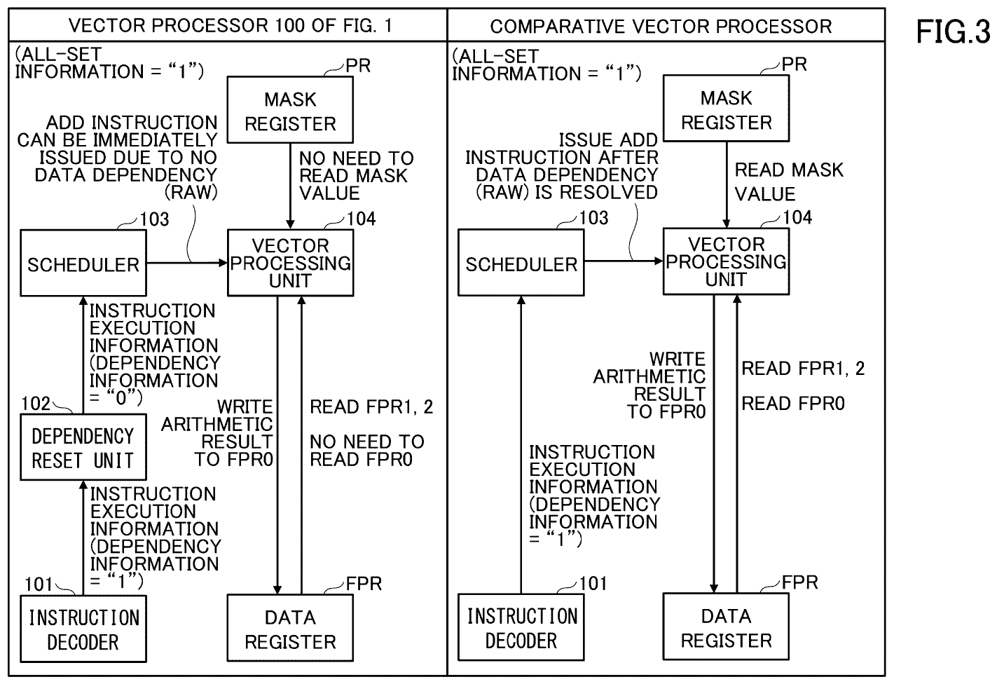

FIG. 3 illustrates examples of the operations in which the vector processor 100 of FIG. 1 and a comparative vector processor execute the ADD instruction illustrated in FIG. 2. FIG. 3 illustrates an example of a method of executing arithmetic operations in the vector processor 100. For simplicity of explanation, the circuit elements of the comparative vector processor are denoted by the same reference numerals as the circuit elements of the vector processor 100. The comparative vector processor does not have the dependency reset unit 102.

The vector processor 100 and the comparative vector processor execute the instruction sequence illustrated in FIG. 1. That is, all-set information for setting all mask values of the mask register PR is set to “1” by decoding the ptrue instruction before decoding the ADD instruction.

In each of the vector processor 100 and the comparative vector processor, the instruction decoder 101 generates the instruction execution information of the ADD instruction based on decoding the ADD instruction. As illustrated in the instruction sequence of FIG. 1, the destination register FPR0 of the ADD instruction has RAW data dependency with the destination register FPR0 of the previous SUB instruction. The mask register PR1 specified by the ADD instruction has RAW data dependency with the mask register PR1 specified by the previous ptrue instruction.

Accordingly, the instruction decoder 101 in each of the vector processor 100 and the comparative vector processor sets the dependency information the register about destination FPR0 (i.e., destination operand) of the ADD instruction and the dependency information about the mask register PR1 to “1”. The instruction decoder 101 outputs the instruction execution information including the configured dependency information.

The dependency reset unit 102 detects, based on the all-set information in the set state, that all the mask values of the mask register PR1 specified by the ADD instruction are set to “1” by the ptrue instruction. The dependency reset unit 102 then resets the dependency information about the destination register FPR0 (i.e., destination operand) of the ADD instruction and the dependency information about the mask register PR1 contained in the instruction execution information of the ADD instruction to “0”. The dependency reset unit 102 outputs the instruction execution information including the reset dependency information to the scheduler 103.

The scheduler 103 of the vector processor 100 receiving the instruction execution information of the ADD instruction detects no data dependency with one or more previous instructions because the dependency information is “0”, and immediately issues the ADD instruction to the vector processing unit 104. That is, before the results of arithmetic operations of the SUB instruction are stored in the register FPR0, the scheduler 103 may issue the ADD instruction to the vector processing unit 104 without reading the results of arithmetic operations from the register FPR0. The scheduler 103 may issue the ADD instruction to the vector processing unit 104 before all the mask values of the mask register PR1 are set to “1” by the ptrue instruction.

The vector processing unit 104 of the vector processor 100 reads and adds data from the source registers FPR1 and FPR2 based on the instruction execution information from the scheduler 103, and stores the results of arithmetic operations in the destination register FPR0. This effectively completes the execution of the ADD instruction illustrated in FIG. 2.

When all the mask values of the mask register PR1 are set to “1” by the ptrue instruction, the results of arithmetic operations of the ADD instruction are stored in all the elements of the destination register FPR0. This arrangement allows for the omission of reading data from the register FPR0 (merging source) holding the results of arithmetic operations of the SUB instruction and the omission of reading the mask values from the mask register PR1, which were described in connection with FIG. 2.

It is also feasible to omit the process of supplying the results of arithmetic operations of the SUB instruction to the destination register FPR0 of the ADD instruction through a bypass route, without first storing them in the register FPR0. By omitting the reading of data from the register FPR0 and the mask register PR1 and the supplying of the results of arithmetic operations of the SUB instruction through a bypass route, the power consumption of the vector processor 100 is effectively reduced.

In contrast, the comparative vector processor does not have the dependency reset unit 102. Thus, the dependency information set to “1” included in the instruction execution information generated by the instruction decoder 101 is output to the scheduler 103 without being reset.

The scheduler 103 of the comparative vector processor holds the instruction execution information of the ADD instruction received from the instruction decoder 101. Based on the dependency information in the set state about the destination register FPR0 (i.e., destination operand) of the ADD instruction, the scheduler 103 determines that there is RAW data dependency with the destination register FPR0 of the previous SUB instruction. Further, based on the dependency information in the set state about the mask register PR1 specified by the ADD instruction, the scheduler 103 determines that there is RAW data dependency with the mask register PR1 specified by the previous ptrue instruction.

Accordingly, the scheduler 103 issues the ADD instruction to the vector processing unit 104 after the data dependency of the register FPR0 between the ADD instruction and the SUB instruction and the data dependency of the mask register PR1 between the ADD instruction and the ptrue instruction are resolved. The comparative vector processor is thus forced to delay the execution of the ADD instruction until the data dependency between the ADD instruction and the SUB instruction and the data dependency between the ADD instruction and the ptrue instruction are resolved.

As a result, the comparative vector processor suffers a decline in instruction execution degradation in efficiency and a processing performance as compared with the vector processor 100. In other words, the vector processor 100 effectively suppresses a decline in instruction execution efficiency and effectively suppresses a degradation in processing performance as compared with the comparative vector processor.

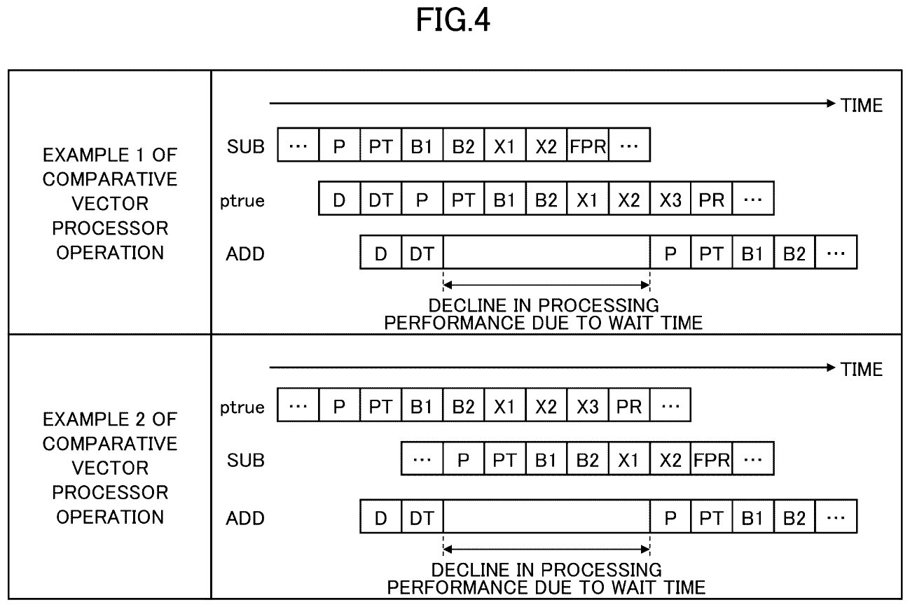

FIG. 4 illustrates an example of the pipeline operation 41 of the comparative vector processor which does not have the dependency reset unit 102 illustrated in FIG. 1. In FIG. 4, the comparative vector processor executes the instruction sequence (SUB, ptrue, and ADD instructions) illustrated in FIG. 1. The comparative vector processor is divided into a plurality of cycles by flip-flops and executes instructions by pipeline processing.

For example, the pipeline cycles includes a decoding cycle D, a decoding transfer cycle DT, a priority cycle P, a priority transfer cycle PT, a buffer cycle B (B1, B2, or the like), an execution cycle X (X1, X2, or the like), and a storage cycle FPR and PR. Hereinafter, these pipeline cycles are also referred to as a D cycle, a DT cycle, a P cycle, a PT cycle, a B cycle, an X cycle, an FPR cycle, and a PR cycle.

In the D cycle, the instruction decoder 101 decodes an instruction. In the DT cycle, instruction execution information generated by the instruction upon decoding the instruction is decoder 101 transferred to the scheduler 103 via the dependency reset unit 102. In the P cycle, an instruction to be issued from the scheduler 103 to the vector processing unit 104 is selected, and instruction execution information about the selected instruction is issued from the scheduler 103 to the vector processing unit 104.

In the PT cycle, the instruction execution information is transferred from the scheduler 103 to the vector processing unit 104. In the B1 and B2 cycles, data (source operands) to be used by the arithmetic units are read from the register FPR. In the X1 and X2 cycles, the vector processing unit 104 performs the arithmetic operations. In the FPR cycle, the results of arithmetic operations by the vector processing unit 104 are stored in the register FPR. In the PR cycle, the results of arithmetic operations by the mask processing unit included in the vector processing unit 104 are stored in the mask register PR.

In the instruction sequence illustrated in FIG. 1, the ptrue instruction sets all mask values in the mask register PR1 to “1,” so that only the results of arithmetic operations by the ADD instruction are stored in the destination register FPR0. However, the circuit as illustrated in FIG. 2 operates such that the results of arithmetic operations by the ADD instruction are selected on an element-by-element basis according to the mask values held in the mask register PR1, and are stored in the destination register FPR0. With this arrangement, thus, the scheduler 103 issues the ADD instruction to the vector processing unit 104 such that the B1 cycle of the ADD instruction is executed after the FPR cycle of the SUB instruction.

Also, the ADD instruction reads the mask values of the mask register PR1 and, based thereon, selects the data to be stored in the destination register FPR0. Therefore, the scheduler 103 issues the ADD instruction to the vector processing unit 104 such that the B1 cycle of the ADD instruction is executed after the PR cycle of the ptrue instruction.

In the operation example 1, the storage cycle FPR for storing the results of arithmetic operations of the SUB instruction in the register FPR0 is completed before, for example, the P cycle of the ADD instruction. Even in this case, the data dependency of the ADD instruction is not eliminated until the storage cycle PR of the ptrue instruction for setting the mask values in the mask register PR1. This prevents the scheduler 103 from executing the P cycle to issue the ADD instruction, after receiving the ADD instruction in the DT cycle. As a result, for example, a wait time of 5 cycles occurs between the DT cycle and the P cycle, which degrades processing performance.

In the operation example 2, the storage cycle PR of the ptrue instruction that sets the mask values in the mask register PR1 is completed before the P cycle of the ADD instruction. Even in this case, the data dependency of the ADD instruction is not eliminated until the storage cycle FPR that stores the results of arithmetic operations of the SUB instruction in the register FPR0. As a result, as in the operation example 1, after the scheduler 103 receives the ADD instruction in the DT cycle, a wait time of 5 cycles occurs before the P cycle of issuing the ADD instruction, which degrades processing performance.

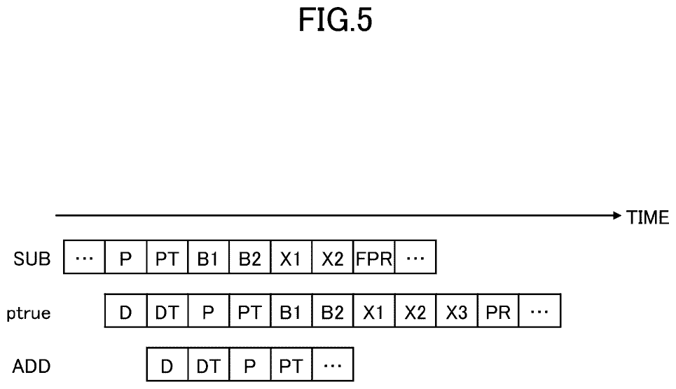

FIG. 5 illustrates an example of the pipeline operation of the vector processor 100 illustrated in FIG. 1. In FIG. 5, the vector processor 100 executes the instruction sequence (SUB, ptrue, and ADD instructions) illustrated in FIG. 1. The vector processor 100 is divided into a plurality of cycles by flip-flops, and executes the instructions by pipeline processing. Each cycle of the pipeline is the same as in FIG. 4.

Upon decoding the ptrue instruction in the D cycle, the instruction decoder 101 detects that all the mask values of the mask register PR1 are to be set to “1”. In the execution of the ADD instruction using the mask register PR1 with all the mask values being “1”, the vector processing unit 104 need not read the mask values from the mask register PR1. Moreover, the vector processing unit 104 need not read data from the destination register FPR0 of the SUB instruction which has data dependency.

Accordingly, as described with reference to FIG. 3, the dependency reset unit 102 resets the set-state dependency information included in the instruction execution information of the ADD instruction to “0” based on all-set information from the instruction decoder 101, followed by outputting the dependency information to the scheduler 103 together with other instruction execution information. For example, the dependency reset unit 102 resets the dependency information about the destination register FPR0 (i.e., destination operand) of the ADD instruction and the dependency information about the mask register PR1.

With this arrangement, the scheduler 103 detects no data dependency among the ADD instruction, the SUB instruction, and the ptrue instruction, and executes the P cycle, immediately following the DT cycle in which the ADD instruction is received, to issue the ADD instruction to the vector processing unit 104. As a result, in FIG. 5, the occurrence of a wait time between the DT cycle and the P cycle as observed in FIG. 4 is avoided, which suppresses a decline in processing performance.

As described above, the embodiment illustrated in FIGS. 1 to 5 effectively executes the subsequent instruction without waiting for the execution of the previous instruction having data dependency when the mask register PR used in the subsequent instruction is set by the ptrue instruction. Further, the subsequent instruction is executed without reading the mask values from the mask register PR. This arrangement suppresses a decline in instruction execution efficiency and a degradation in processing performance, compared with the comparative vector processor.

Moreover, when the mask register PR specified by the subsequent instruction is set by the ptrue instruction, the reading of the data from the destination register FPR of the previous instruction having data dependency and the mask values from the mask register PR1 is effectively omitted. Omitting the reading of the register FPR and the reading of the mask register PR1 effectively reduces the power consumption of the vector processor 100.

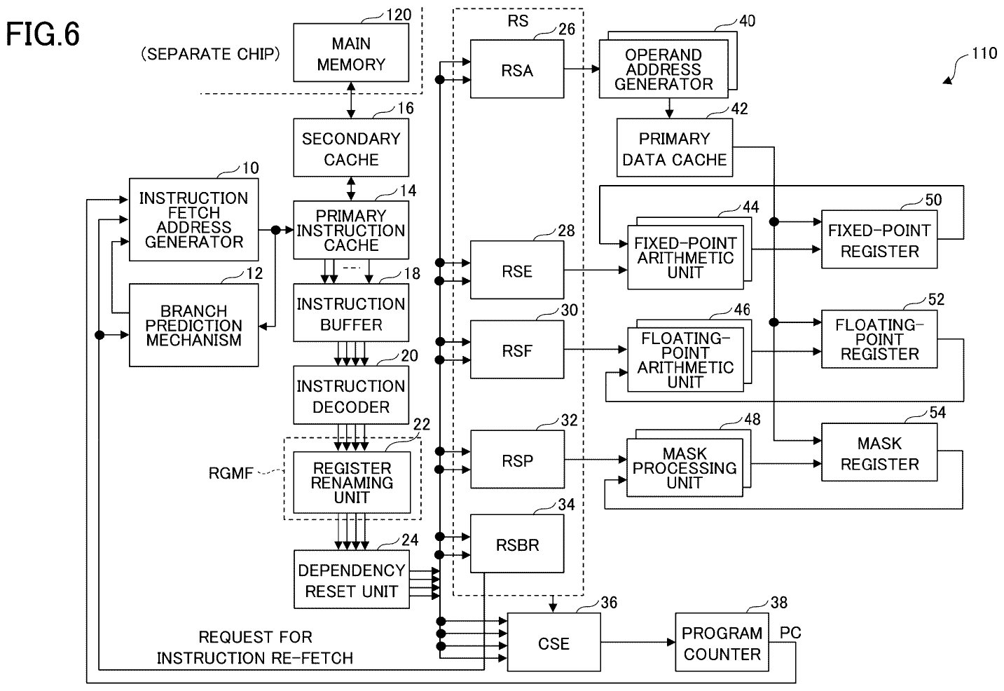

FIG. 6 illustrates an example of the vector processor according to another embodiment. Elements and functions similar to those described in FIGS. 1 to 5 may not be described in detail. The vector processor 110 illustrated in FIG. 6 includes an instruction fetch address generator 10, a branch prediction mechanism 12, a primary instruction cache 14, a secondary cache 16, an instruction buffer 18, an instruction decoder 20, a register renaming unit 22, and a dependency reset unit 24.

The vector processor 110 further includes a reservation station RS, a commit control unit 36, and a program counter 38. Hereinafter, the commit control unit 36 is also referred to as a commit stack entry (CSE) 36. The reservation station RS includes a reservation station for address generation (RSA) 26, a reservation station for execution (RSE) 28, a reservation station for floating point (RSF) 30, a reservation station for predicate (RSP) 32, and a reservation station for branch (RSBR) 34.

In the following, the term “reservation station RS” may be used to refer to RSA 26, RSE 28, RSF 30, RSP 32, and RSBR 34 when no distinction is needed. The RSF 30 is an example of a scheduler that holds instruction execution information for each instruction and sequentially outputs instruction execution information for the instruction whose data dependency has been eliminated, based on the dependency information contained in the held instruction execution information.

The vector processor 110 further includes an operand address generator 40, a primary data cache 42, a fixed-point arithmetic unit 44, a floating-point arithmetic unit 46, a mask processing unit 48, a fixed-point register 50, a floating-point register 52, and a mask register 54. The configuration of the vector processor 110 is not limited to the example illustrated in FIG. 6. A case where the vector processor 110 executes vector arithmetic operations will be described below.

The instruction fetch address generator 10 generates a fetch address for the next instruction based on the value of the program counter 38, the result of prediction made by the branch prediction mechanism 12, or the address included in the instruction refetch request from the RSBR 34. The instruction fetch address generator 10 supplies the generated fetch address for the next instruction to the primary instruction cache 14, and fetches the instruction from the primary instruction cache 14.

Based on the address generated by the instruction fetch address generator 10, the branch prediction mechanism 12 predicts whether the conditional branch instruction will be taken. Upon predicting that the branch is taken, the branch prediction mechanism 12 supplies the branch destination address (target address) to the instruction fetch address generator 10.

The primary instruction cache 14 extracts the instruction from the location indicated by the address from the instruction fetch address generator 10, and transmits the extracted instruction to the instruction! buffer 18. Instructions held by the n cache 14 include arithmetic primary instruction executing using operations the instructions for fixed-point arithmetic unit 44 or the floating-point arithmetic unit 46, instructions for updating the mask register 54, memory access instructions, and branch instructions. The primary instruction cache 14 may not hold the instruction in the location indicated by the address specified for the instruction, and, in such a case, issues an access request to the secondary cache 16, followed by extracting the instruction from the secondary cache 16.

The secondary cache 16 extracts the instruction from the location indicated by the address included in the access request, and transmits the extracted instruction to the primary instruction cache 14. The secondary cache 16 may not hold the instruction in the location indicated by the address included in the access request, and, in such a case, issues an access request to the main memory 120 to read the instruction from the main memory 120. For example, the main memory 120 may be embedded in a semiconductor chip which is different from the semiconductor chip containing the vector processor 110. The secondary cache 16 may hold not only instructions but also data.

The instruction buffer 18 holds, for example, a plurality of instructions received from the primary instruction cache 14 in parallel, and outputs these instructions to the instruction decoder 20 in parallel. The instruction decoder 20 has, for example, a plurality of decode slots for parallel decoding of respective instructions output from the instruction buffer 18. Each decode slot determines a reservation station RS (RSA 26, RSE 28, RSF 30, RSP 32 or RSBR 34) corresponding to the fixed-point arithmetic unit 44, the floating-point arithmetic unit 46, the mask processing unit 48, or the like which executes a corresponding instruction. Each decode slot incorporates, into the instruction execution information, information indicative of the reservation station RS to which the instruction is supplied, for transmission to the register renaming unit 22.

The instruction decoder 20 allocates instruction identifiers to the instructions in the order of instructions listed in the program executed by the vector processor 110, and supplies the allocated instruction n identifiers together with decoded instructions (decoded results) to the CSE 36. The instruction buffer 18 and the instruction decoder 20 process a plurality of instructions in parallel without changing the order of instructions listed in the program (in-order).

The register renaming unit 22 has a renaming map for converting the logical register numbers specified by the instruction operands into physical register numbers corresponding to the fixed-point register 50, the floating-point register 52, and the mask register 54, and has a free list indicating free physical registers. By converting the logical register numbers specified by the instruction operands into physical register numbers, out-of-order execution by the reservation station RS becomes possible.

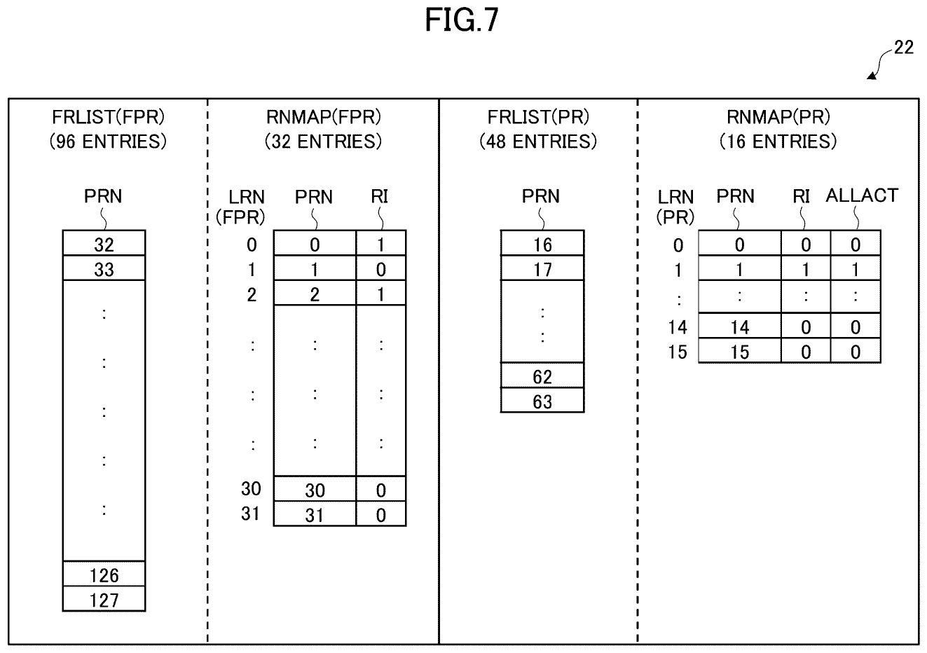

The register renaming unit 22 incorporates the physical register numbers into the instruction execution information, and supplies the instruction execution information to the reservation station RS via the dependency reset unit 24. The instruction execution information output from the instruction decoder 20 includes information indicating to which of RSA 26, RSE 28, RSF 30, RSP 32, or RSBR 34 the instruction execution information is to be supplied. An example of the register renaming unit 22 is illustrated in FIG. 7.

In FIG. 6, the vector processor 110 adopts a physical register map method that converts logical register numbers into physical register numbers using the register renaming unit 22. Alternatively, the update buffer method may as well be adopted to realize the same operations as in FIGS. 7 to 10, and effectively suppresses a decline in processing performance when the all-set instruction ptrue described later is executed.

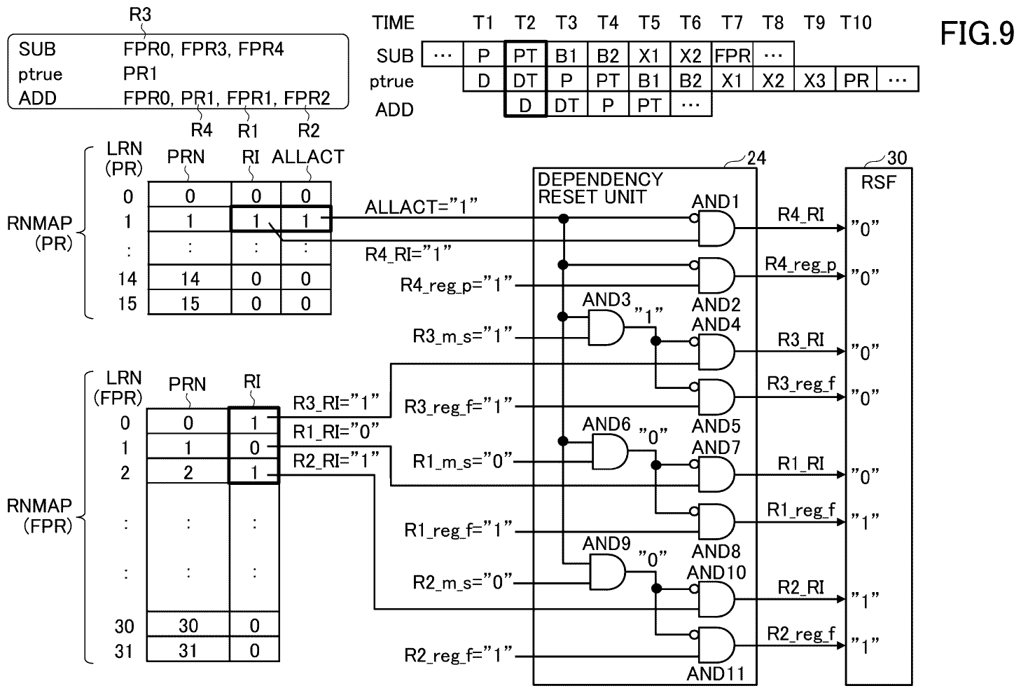

The register renaming unit 22 is included in the register management facility RGMF. The register management facility RGMF generates a read signal (reg_f illustrated in FIG. 9) that instructs reading of data (merging source) already stored in the destination register based on instruction execution information from the instruction decoder 20. Further, the register management facility RGMF generates a read signal (reg_p illustrated in FIG. 9) that instructs reading of a mask value from the mask register 54 based on instruction execution information from the instruction decoder 20.

For example, when the instruction decoded by the instruction decoder 20 is a memory access instruction (load instruction or store instruction), the instruction is supplied to the RSA 26 via the dependency reset unit 24. When the instruction decoded by the instruction decoder 20 is a fixed-point arithmetic instruction, the instruction is supplied to the RSE 28 via the dependency reset unit 24. When the instruction decoded by the instruction decoder 20 is a floating-point arithmetic instruction, the instruction is supplied to the RSF 30 via the dependency reset unit 24. When the instruction decoded by the instruction decoder 20 is an access instruction (load instruction or store instruction) of the mask register 54, the instruction is supplied to the RSP 32 via the dependency reset unit 24. When the instruction decoded by the instruction decoder 20 is a branch instruction, the instruction is supplied to the RSBR 34 via the dependency reset unit 24.

The dependency reset unit 24 transfers instruction execution information about instructions such as an addition instruction ADD, a subtraction instruction SUB, and a multiplication instruction MUL received from the register renaming unit 22 to the reservation station RS. For example, an all-set instruction ptrue may be executed with respect to the mask register 54 used by the subsequent instruction, and there is a RAW data dependency in the destination register between the subsequent instruction and the previous instruction. In this case, the dependency reset unit 24 resets, for example, the dependency information about the destination register for transfer to the reservation station RS. For example, the previous instruction is the SUB instruction of the instruction sequence illustrated in FIG. 1, and the subsequent instruction is the ADD instruction illustrated in FIG. 1. An example of the circuit configuration of the dependency reset unit 24 is illustrated in FIG. 9.

The RSA 26 holds memory access instructions received sequentially from the instruction decoder 20, and outputs these memory access instructions to the operand address generator 40 in the order of their readiness for execution (out-of-order). The operand address generator 40 generates addresses based on the memory access instructions received from the RSA 26, and transmits the generated addresses to the primary data cache 42. In FIG. 6, although the vector processor 110 has a plurality of operand address generators 40, the number of operand address generators 40 may be one.

When a load instruction is executed, for example, the primary data cache 42 retrieves data held in the location indicated by the address from the operand address generator 40. The primary data cache 42 outputs the retrieved data to the fixed-point register 50, the floating-point register 52, or the mask register 54. The primary data cache 42 may not have data in the location indicated by the address, and, in such a case, transmits an access request to the secondary cache 16 to retrieve data from the secondary cache 16, similarly to the primary instruction cache 14.

The RSE 28 holds fixed-point arithmetic instructions sequentially received from the instruction decoder 20, and outputs these arithmetic instructions to the fixed-point arithmetic unit 44 in the order of their readiness for execution (out-of-order). The RSF 30 holds floating-point arithmetic instructions sequentially received from the instruction decoder 20, and outputs these arithmetic instructions to the floating-point arithmetic unit 46 in the order of their readiness for execution (out-of-order). The RSP 32 holds the access instructions with respect to the mask register 54 received sequentially from the instruction decoder 20, and outputs these access instructions to the mask processing unit 48 in the order of their readiness for execution (out-of-order).

The RSBR 34 retains branch instructions received sequentially from the instruction decoder 20 until it outputs a completion report upon a branch taken or a branch not taken being determined. The RSBR 34 completes the processing of the branch instructions in order, sends completion signals to the CSE 36, and causes the CSE 36 to commit the branch instructions. When the branch prediction error is detected, the RSBR 34 outputs an instruction re-fetch request to the instruction fetch address generator 10 and the branch prediction mechanism 12.

The CSE 36 includes a queue for storing the instructions received via the register renaming unit 22 in the order of instructions listed in the program, and a completion processing unit for completing the processing of the instructions. The completion processing unit handles the in-order completion of instruction processing in the order of instructions listed in the program, based on the information in the queue and the completion reports of instructions executed through the reservation stations RS. In completion processing, the completion processing unit commits (ends) the instructions corresponding to the completion reports among the instructions waiting for completion reports stored in the queue of the CSE 36, and updates the resources.

Based on an instruction from the CSE 36, the program counter 38 updates the memory address indicating the location at which an instruction is stored, and outputs the updated memory address as the program counter PC to the instruction fetch address generator 10.

The fixed-point arithmetic unit 44 acquires the fixed-point data to be used in an arithmetic operation from the fixed-point register and stores the result of the arithmetic operation in the fixed-point register 50. The vector processor 110 may have a plurality of fixed-point arithmetic units 44 in order to perform parallel execution of fixed-point arithmetic instructions decoded in parallel by the instruction decoder 20.

The floating-point arithmetic unit 46 acquires the floating-point data to be used in an arithmetic operation from the floating-point register 52, and stores the result of the arithmetic operation in the floating-point register 52. It should be noted that the floating-point arithmetic unit 46 may include arithmetic units for executing a sum-of-products operation, an integer operation, a logical operation, etc. The vector processor 110 may have a plurality of floating-point arithmetic units 46 in order to perform parallel execution of the floating-point arithmetic instructions decoded in parallel by the instruction decoder 20.

The mask processing unit 48 acquires the mask values from the mask register 54, and stores the mask values updated by arithmetic operations in the mask register 54. Upon receiving the instruction execution information of an all-set instruction ptrue from the RSP 32, the mask processing unit 48 sets all the mask values in the mask register 54 to “1”. The vector processor 110 may have a plurality of mask processing units 48.

The fixed-point register 50 has a plurality of entries for holding data to be used for the arithmetic operation to be executed by the fixed-point arithmetic unit 44 and the result of the arithmetic operation executed by the fixed-point arithmetic unit 44. In the following, the plurality of entries of the fixed-point register 50 are also referred to as the fixed-point register 50.

The floating-point register 52 has a plurality of entries for holding data to be used for the operation to be executed by the floating-point arithmetic unit 46 and the execution result of the operation by the floating-point arithmetic unit 46. In the following, the plurality of entries of the floating-point register 52 are also referred to as the floating-point register 52.

The mask register 54 has a plurality of entries for storing mask values of “0” or “1” for respective vector elements. Hereinafter, a plurality of entries of the mask register 54 are also referred to as the mask register PR.

A description given below in connection with FIGS. 7 to 10 is directed to an example of executing a floating-point arithmetic instruction using the floating-point arithmetic unit 46, the floating-point register 52, the mask processing unit 48 for floating-point operations, and the mask register 54 for floating-point operations. FIGS. 7 to 10 illustrate an example of a method of executing arithmetic operations in the vector processor 110. FIGS. 7 to 10 is also applicable to the execution of a fixed-point arithmetic instruction. The execution of a fixed-point arithmetic instruction involves using the fixed-point arithmetic unit 44, the fixed-point register 50, the mask processing unit 48 for fixed-point operations, and the mask register 54 for fixed-point operations.

FIG. 7 illustrates an example of the register renaming unit 22 illustrated in FIG. 6. The register renaming unit 22 has a renaming map RNMAP (FPR) and a free list FRLIST (FPR) for the floating-point register FPR. The register renaming unit 22 also has a renaming map RNMAP (PR) and a free list FRLIST (PR) for the mask register PR. Although not illustrated, the register renaming unit 22 may have a renaming map and a free list for fixed-point operations and a renaming map and a free list corresponding to the mask register 54 for fixed point operations.

The renaming map RNMAP (FPR) has 32 entries each configured to store a physical register number PRN and a dependency flag RI (Read Interlock) that is set to “1” when there is RAW data dependency. The 32 entries correspond to the logical register numbers LRN of 32 logical registers that can be specified as operands of instructions for floating-point operations. The renaming map RNMAP (FPR) is an example of the first renaming map. The 32 entries are an example of the first entries, and the dependency flag RI is an example of dependency information.

The free list FRLIST (FPR) has 96 entries configured to store physical register numbers PRN of the free floating-point registers FPR that are not stored in the renaming map RNMAP (FPR). Accordingly, the respective physical register numbers PRN indicating all the 128 floating-point registers FPR can be stored in either the renaming map RNMAP (FPR) or the free list FRLIST (FPR). The instruction decoder 20 effectively identifies the physical register number PRN of the floating-point register FPR corresponding to the logical register number LRN specified as the operand of the subsequent instruction by accessing the renaming map RNMAP (FPR) using the logical register number LRN.

The register renaming unit 22 sequentially extracts the physical register numbers PRN from the free list FRLIST (FPR), each at the D-cycle of a corresponding pipeline that executes an instruction including the floating-point register FPR as an operand. The register renaming unit 22 stores the physical register numbers PRN extracted from the free list FRLIST (FPR) in the renaming map RNMAP (FPR).

The old physical register number PRN stored in the renaming map RNMAP (FPR) before being replaced by the new physical register number PRN is stored in the free list FRLIST (FPR) at the entry from which the new physical register number PRN is extracted. With this arrangement, any of the 128 physical floating-point registers FPR are selectively used by specifying any of the 32 logical register numbers LRN as the operand of an instruction.

The renaming map RNMAP (PR) has 16 entries each configured to store a physical register number PRN, a dependency flag RI, and an all-active flag ALLACT that is set to “1” when an all-set instruction ptrue is executed. The 16 entries correspond to the logical register numbers LRN of the 16 mask registers PR that can be specified as operands of instructions to update the mask values. The renaming map RNMAP (PR) is an example of the second renaming map. The 16 entries are an example of the second entries.

The free list FRLIST (PR) has 48 entries configured to store the physical register numbers PRN of free mask registers PR that are not stored in the renaming map RNMAP (PR). With this arrangement, the respective physical register numbers PRN indicating all the 64 mask registers PR can be stored in either the renaming map RNMAP (PR) or the free list FRLIST (PR).

The register renaming unit 22 sequentially extracts the physical register numbers PRN from the free list FRLIST (PR), each at the D-cycle of a corresponding pipeline that executes an instruction including the mask register PR as an operand. The register renaming unit 22 stores the physical register numbers PRN extracted from the free list FRLIST (PR) in the renaming map RNMAP (PR).

The old physical register number PRN stored in the renaming map RNMAP (PR) before being replaced by the new physical register number PRN is stored in the free list FRLIST (PR) at the entry from which the new physical register number PRN is extracted. With this arrangement, any of the 64 physical mask registers PR is selectively used by specifying any of 16 logical register numbers LRN as the operand of an instruction.

As described above, in the D cycle of a pipeline, the decoder 20 decodes the instruction and the register renaming unit 22 converts the logical register number LRN into the physical register number PRN. It may be noted that the decoder 20 reads the information to be used for the decoded instruction from the renaming maps RNMAP (FPR) and RNMAP (PR) in the D cycle. The information read by the decoder 20 becomes available in the DT cycle.

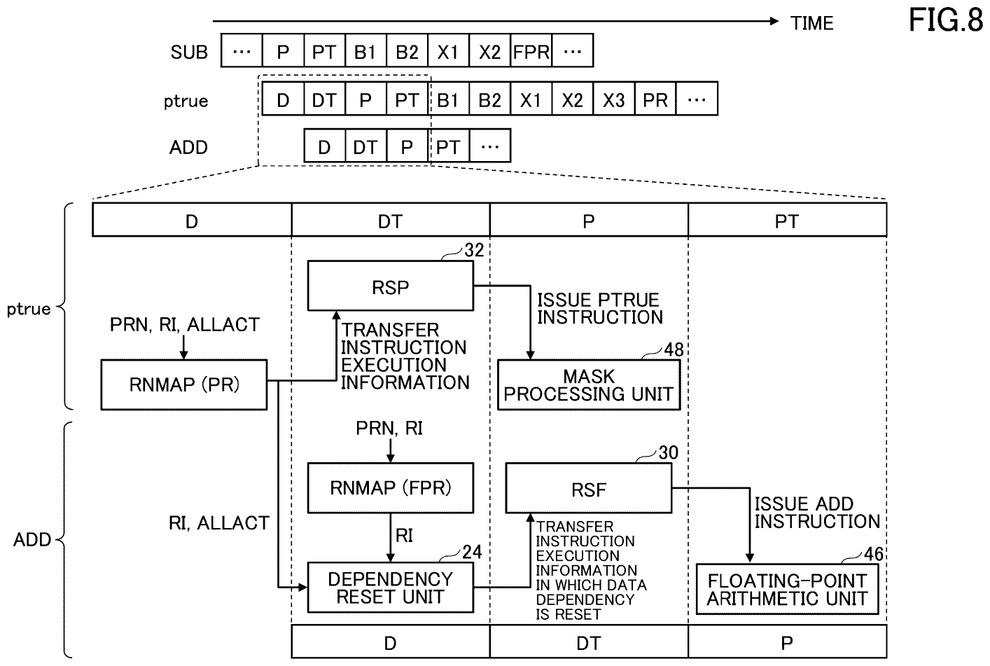

FIG. 8 illustrates an example of a pipeline operation of the vector processor 110 illustrated in FIG. 6. The instruction sequence executed by the vector processor 110 is, for example, the same as that illustrated in FIG. 1. The pipeline operation illustrated in FIG. 8 focuses on the instruction execution information input into and output from the renaming maps RNMAP (PR) and RNMAP (FPR) by the ptrue instruction and the ADD instruction. Detailed descriptions of substantially the same operations as those illustrated in FIG. 5 are omitted.

In the D-cycle of the ptrue instruction, the register renaming unit 22 stores the physical register number PRN, the dependency flag RI, and the all-active flag ALLACT in the renaming map RNMAP (PR) corresponding to the operand (logical register number LRN) of the ptrue instruction. The dependency flag RI and the all-active flag ALLACT held in the renaming map RNMAP (PR) are output to the dependency reset unit 24 in association with the physical register number PRN.

Subsequently, in the DT cycle of the ptrue instruction, the instruction execution information held in the renaming map RNMAP (PR) is transferred to the RSP 32 together with the instruction execution information of the ptrue instruction generated by the instruction decoder 20. Although not illustrated, the information held in the renaming map RNMAP (PR) and the information generated by the register management facility RGMF are transferred to the RSP 32 via the dependency reset unit 24.

In the D cycle of the ADD instruction, the register renaming 22 unit stores the physical register numbers PRN in the renaming map RNMAP (FPR) corresponding to the respective operands (logical register numbers LRN) of the ADD instruction. The register renaming unit 22 also updates the dependency flag RI in the entry of the renaming map RNMAP (FPR) that stores the physical register number PRN.

The dependency flag RI held in the renaming map RNMAP (FPR) is output to the dependency reset unit 24 in association with the physical register number PRN. In the D cycle of the ADD instruction, the all-active flag ALLACT output from the renaming map RNMAP (PR) reveals that a ptrue instruction is issued with respect to the mask register PR1 specified in the ADD instruction.

Subsequently, in the P cycle of the ptrue instruction, the RSP 32 decides to issue the ptrue instruction and issues the ptrue instruction to the mask processing unit 48. The mask processing unit 48 executes the ptrue instruction.

In the DT cycle of the ADD instruction, the instruction execution information the of ADD instruction is transferred to the RSP 32. A part of the instruction execution information that is to be transferred to the RSF 30 is transferred via the dependency reset unit 24 to the RSF 30.

For example, the dependency flag RI and the all-active flag ALLACT held in the renaming map RNMAP (FPR) and RNMAP (PR) are transferred to the RSF 30 via the dependency reset unit 24. In addition, information indicating the merging source generated by the register management facility RGMF is transferred to the RSF 30 via the dependency reset unit 24. This arrangement allows for resetting of the instruction execution information in the set state indicating the data dependency of the destination register FPR0 that is specified in the SUB instruction and that is the merging source of the ADD instruction and the data dependency of the mask register PR1 specified in the ptrue instruction, as will be described in FIG. 9

In the P cycle of the ADD instruction, the RSF 30 decides to issue the ADD instruction and issues the ADD instruction to the floating-point arithmetic unit 46. The P cycle of the ADD instruction is executed in the cycle following the DT cycle of the ADD instruction. The floating-point arithmetic unit 46 then executes the ADD instruction.

FIG. 9 illustrates an example of the circuit and functioning of the dependency reset unit 24 illustrated in FIG. 6. FIG. 9 illustrates the logic circuit of the dependency reset unit 24 used when the ADD instruction included in the instruction sequence is executed, and illustrates the state of signals input into and output from the dependency reset unit 24.

The instruction sequence illustrated in FIG. 9 is the same as the instruction sequence illustrated in FIG. 1. In the ADD instruction, the mask register PR1 is an example of a first source operand, and the floating-point register FPR0 is an example of a destination operand. The renaming map RNMAP (PR) corresponding to the mask register 54 is updated at the D cycle (time T1) of the ptrue instruction.

For example, the dependency reset unit 24 includes 11 AND gates AND1 to AND11. The floating-point registers FPR1, FPR2, and FPR0 and the mask register PR1, which are the source operands for which the presence or absence of data dependency is determined in the ADD instruction, are respectively assigned to the register numbers R1, R2, R3, and R4 used in the pipeline.

The renaming map RNMAP (PR) illustrated in FIG. 9 shows the state observed when the renaming map RNMAP (PR) is updated after the instruction decoder 20 decodes the ptrue instruction at time T1. By decoding the ptrue instruction, for example, the dependency flag RI and the all-active flag ALLACT in the entry of the mask register PR1 of the renaming map RNMAP (PR) are set to “1”. Hereinafter, the dependency flag RI of the mask register PR1 assigned to the register number R4 is also referred to as the dependency flag R4_RI.

The renaming map RNMAP (FPR) illustrated in FIG. 9 shows the state observed when the renaming map RNMAP (FPR) is updated after the instruction decoder 20 decodes the ADD instruction at time T2. By decoding the ADD instruction, for example, the dependency flag RI included in the entry of the floating-point register FPR0 in the renaming map RNMAP (FPR) is set to “1”. Also, by decoding the ADD instruction, the dependency flags RI included in the respective entries of the floating-point registers FPR1 and FPR2 in the renaming map RNMAP (FPR) are updated to “0” and “1”, respectively. Hereinafter, the dependency flags RI of the floating-point registers FPR0, FPR1 and FPR2 assigned to the register numbers R3, R1 and R2 are also referred to as the dependency flags R3_RI, R1_RI and R2_RI, respectively.

In the dependency reset unit 24, a circle shown at one input of each of the AND gates AND1, AND2, AND4, AND5, AND7, AND10 AND8, and AND11, specifically the input receives that a signal including the logic of the all-active flag ALLACT, indicates inversion of the logic.

The all-active flag ALLACT is input into one input of each of the AND gates AND3, AND6 and AND9, and one of the merging source signals R3_m_s, R1_m_s and R2_m_s is input into the other input. Each of the merging source signals R3_m_s, R1_m_s and R2_m_s is set to “1” by the instruction decoder 20 when a corresponding one of the floating-point registers FPR0, FPR1 and FPR2 is a merging source (destination register). Each of the merging source signals R3_m_s, R1_m_s and R2_m_s is reset to “0” by the instruction decoder 20 when a corresponding one of the floating-point registers FPR0, FPR1 and FPR2 is not a merging source.

In the example illustrated in FIG. 9, since the floating-point register FPR0 is the merging source, the merging source signal R3_m_s is set to “1”, and the other merging source signals R1_m_s and R2_m_s are reset to “0”. As a result, the AND gate AND3 outputs “1”, and the AND gates AND6 and AND9 output “0”. It may be noted that the instruction decoder 20 is capable of determining which of R1, R2, and R3 is the merging source.

The read signals R4_reg_p, R3_reg_f, R1_reg_f, and R2_reg_f are generated by the register management facility RGMF. The read signal R4_reg_p is an example of the second read signal, and the read signal R3_reg_f is an example of the first read signal. The read signals R1_reg_f and R2_reg_f are examples of the third read signals.

The read signal R4_reg_p is set to “1” when the mask values are read from the corresponding mask register PR1, and is reset to “0” when the mask values are not read from the corresponding mask register PR1. Each of the read signals R3_reg_f, R1_reg_f and R2_reg_f is set to “1” when data is read from the floating-point register (source corresponding operand), and is reset to “0” when data is not read from the corresponding floating-point register (source operand).

In the example illustrated in FIG. 9, the read signal R4_reg_p is set to “1” because it corresponds to the mask register PR1 (merging source) designated in the ptrue instruction and used by the ADD instruction. The read signal R3_reg_f is set to “1” because it corresponds to the merging source where the results of arithmetic operations of the SUB instruction are stored. The read signals R1_reg_f and R2_reg_f are set to “1” because they correspond to the source operands of the ADD instruction.

The AND gate AND1 receives the inversion of the all-active flag ALLACT that is “1”, thereby resetting the value “1” of the dependency flag R4_RI to “O”, and outputs the result to the RSF 30. The AND gate AND1 is an example of the first reset circuit that transfers to the RSF 30 the value obtained by resetting the dependency flag R4_RI held as an entry in the renaming map RNMAP (PR) in which all-set information is set.

The AND gate AND2 receives the inversion of the all-active flag ALLACT that is “1”, thereby resetting the value “1” of the read signal R4_reg_p to “0”, and outputs the result to the RSF 30. The AND gate AND2 is an example of the third reset circuit that resets the read signal R4_reg_p and transfers the result to the RSF 30 when the source operand indicates the mask register specified in the ptrue instruction.

The AND gate AND4 receives the inversion of “1” from the AND gate AND3, thereby resetting the value “1” of the dependency flag R3_RI to “0”, and outputs the result to the RSF 30. The AND gate AND4 is an example of the first reset circuit that transfers to the RSF 30 the value obtained by resetting the dependency information R3_RI held as an entry in the renaming map RNMAP (FPR), which corresponds to the destination operand FPR0 specified in the subsequent instruction ADD that uses the mask register PR1 specified in the ptrue instruction as the source operand.

The AND gate AND5 receives the inversion of “1” from the AND gate AND3, t thereby resetting the value “1” of the read signal R3_reg_f to “0”, and outputs the result to the RSF 30. The AND gate AND5 is an example of the second reset circuit that resets the read signal R3_reg_f and transfers the result to the RSF 30 when the source operand of the ADD instruction indicates the mask register PR1 specified in the ptrue instruction.

The AND gate AND7 receives the inversion of “O” from the AND gate AND6, thereby outputting the value “0” of the dependency flag R1_RI as it is to the RSF 30. The AND gate AND8 receives the inversion of “O” from the AND gate AND6, thereby outputting the value “1” of the read signal R1_reg_f as it is to the RSF 30.

The AND gate AND10 receives the inversion “0” from AND gate AND9, thereby outputting the value “1” of the dependency flag R2_RI to the RSF 30 as it is. The AND gate AND11 receives the inversion of “0” from the AND gate AND9, thereby outputting the value “1” of the read signal R2_reg_f to the RSF 30 as it is.

The AND gates AND6, AND7, AND9, and AND10 are examples of the first avoidance circuits that avoid resetting, and transfer to the RSF 30, the dependency flags R1_RI and R2_RI held in the renaming map RNMAP (FPR), which correspond to the operands that are not the merging source among the operand floating-point registers FPR specified in the subsequent instruction.

The AND gates AND6, AND8, AND9, and AND11 are examples of the second avoidance circuits that avoid resetting, and transfer to the RSF 30, the read signals R1_reg_f and R2_reg_f that instruct reading of data from the operands that are not the merging source among the operands, except for the mask register PR, specified in the subsequent instruction.

It may be noted that the value “1” of the dependency flag R2_RI is used in the above description for the purpose of explaining the functioning of the AND gate AND11. In actuality, the dependency flag R2_RI is reset to “0” when the RSF 30 is able to issue the ADD instruction to the floating-point arithmetic unit 46 at time T4,

As described at the time above, of execution of the ADD instruction, the dependency reset unit 24 resets the read signals R4_reg_p and R3_reg_f as well as the dependency flags R4_RI and R3_RI for the merging sources, and outputs the results to the RSF 30. With this arrangement, the RSF 30 effectively issues the ADD instruction to the floating-point arithmetic unit 46 before the results of arithmetic operations of the SUB instruction are stored in the register FPR0, as in the functioning of the vector processor 100 illustrated in FIG. 3.

In addition, the RSF 30 effectively issues the ADD instruction to the floating-point arithmetic unit 46 before all the mask values of the mask register PR1 are set to “1” by the ptrue instruction. As a result, a delay in the execution of addition after decoding the ADD instruction is effectively avoided, which suppresses a degradation in processing performance.

Furthermore, when the ADD instruction is executed, the reading of data from the floating-point register FPR0 holding the operation results of the SUB instruction and the reading of the mask values from the mask register PR1 is effectively omitted. Omitting the reading of the register FPR0 and the reading of the mask register PR1 effectively reduces the power consumption of the vector processor 110.

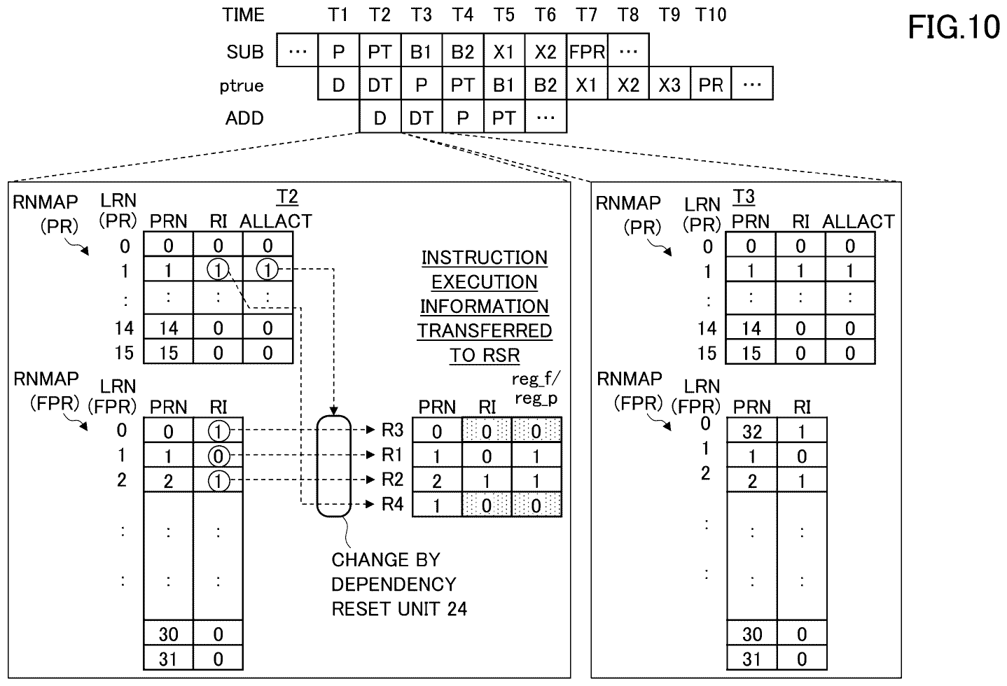

FIG. 10 illustrates an example of the process of resetting the dependency flag RI by the dependency reset unit 24 in the D-cycle (T2) of the addition instruction ADD illustrated in FIG. 9. For the sake of simplicity of illustration, the number of parallel instructions is set to “1,” but the number of parallel instructions may be increased by a superscalar processor scheme.

The renaming map RNMAP (PR) illustrated at time T2 illustrates the state set by the instruction to update the mask register 54 decoded before time T1. The physical register number PRN, the dependency flag RI and the all-active flag ALLACT illustrated in the entry of the mask register PR1 in the renaming map RNMAP (PR) are set to “1” by the decoding of the ptrue instruction at time T1.

The renaming map RNMAP (FPR) illustrated at time T2 illustrates the state set by the instruction decoded before time T1, similarly to the renaming map RNMAP (PR). For example, the dependency flags RI of the floating-point registers FPR0, FPR1 and FPR2 in the renaming map RNMAP (FPR) are updated to “1”, “0” and “1”, respectively

At time T2, the instruction decoder 20 decodes the ADD instruction. The instruction decoder 20 reads the physical register number PRN, the dependency flag RI, and the all-active flag ALLACT held in the entry (PR1) of the renaming map RNMAP (PR) corresponding to the source operand (PR1) of the ADD instruction.

The instruction decoder 20 also reads the physical register number PRN and the dependency flag RI held in the entries (FPR0-FPR2) of the renaming map RNMAP (FPR) corresponding to the merging source (FPR0) and the source operands (FPR1, FPR2) of the ADD instruction. As described in connection with FIG. 9, the dependency flag RI (R2_RI in FIG. 9) of the register number R2 corresponding to the floating-point register FPR2 may have been reset to “0” in reality.

Although not illustrated, the instruction decoder 20 sets the read signals R1_reg_f, R2_reg_f, R3_reg_f, and R4_reg_p illustrated in FIG. 9 to “1”. Then, the instruction decoder 20 outputs the information read from the renaming maps RNMAP (PR) and RNMAP (FPR) and the read signals R1_reg_f, R2_reg_f, R3_reg_f, and R4_reg_p to the dependency reset unit 24.

The dependency reset unit 24 changes the logical values of the instruction execution information held in the renaming maps RNMAP (PR) and RNMAP (FPR) received from the instruction decoder 20. As illustrated in FIG. 9, the dependency reset unit 24 resets the dependency flags R4_RI and R3_RI in the set state to “0” and resets the read signals R3_reg_f and R4_reg_p in the set state to “0”. The instruction execution information changed by the dependency reset unit 24 is output to the RSF 30 at time T3.

At time T3, the register renaming unit 22 refers to the free list FRLIST (FPR) illustrated in FIG. 7, and changes the physical register number PRN of the floating-point register FPR0 used in the ADD instruction to “32”. This determines the entry of the floating-point register 52 into which the results of arithmetic operations of the ADD instruction are stored. Operations after time T4 are similar to the operations of the scheduler 103, the vector processing unit 104, the mask register PR, and the data register FPR of the vector processor 100 illustrated in FIG. 3.

For example, the RSF 30 determines that there is no data dependency between the ADD instruction and the previous SUB instruction, or between the ADD instruction and the ptrue instruction, based on the dependency flag RI. Based on this determination, the RSF 30 effectively executes the P-cycle of the ADD instruction at time T4 and issues the ADD instruction to the floating-point arithmetic unit 46. Since the read signals R3_reg_f and R4_reg_p are reset to “0”, read accesses to the floating-point register FPR0 and the mask register PR1 are effectively omitted, thereby reducing power consumption.

As described above, the embodiment illustrated in FIGS. 6 to 10 can provide the same effects as in the embodiment illustrated in FIGS. 1 to 5. For example, when the mask register PR used in the subsequent instruction is set by the ptrue instruction, the subsequent instruction can be executed without waiting for the execution of the previous instruction having data dependency. Moreover, the subsequent instruction can be executed without reading the mask values from the mask register PR. This arrangement effectively suppresses a decline in the instruction execution efficiency of the vector processor 110, and suppresses a degradation in processing performance.

Moreover, when the mask register PR specified in the subsequent instruction is set by the ptrue instruction, the reading of the data from the destination register FPR of the previous instruction having data dependency and the mask values from the mask register PR1 can be omitted. Omitting the reading of the register FPR and the reading of the mask register PR1 effectively reduces the power consumption of the vector processor 110.

In this embodiment, furthermore, the AND gates AND3, AND6, and AND9 of the dependency reset unit 24 generate logical products between the all-active flag ALLACT and the merging source signals R3_m_S, R1_m_S, and R2_m_S, respectively. This arrangement enables the resetting of only the dependency flags RI corresponding to the floating-point registers FPR that are the merging sources. Further, this arrangement serves to prevent a change in the logic value of the dependency flag RI corresponding to the floating-point register FPR that is not the margin source. This arrangement also serves to prevent a change in the logic value of a read signal such as R1_reg_f corresponding to the floating-point register FPR that is not the margin source. As a result, the malfunction of the vector processor 110 due to the provision of the dependency reset unit 24 can be prevented.

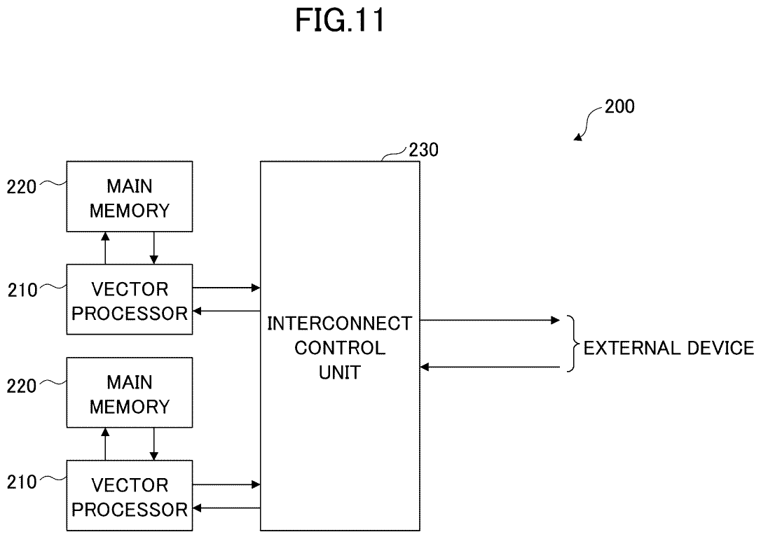

FIG. 11 illustrates an example of an information processing system including the vector processor illustrated in FIG. 1 or FIG. 6. For example, the information processing system illustrated in FIG. 11 is a server 200 or the like. The server 200 includes a plurality of vector processors 210, a plurality of main memories 220, and an interconnect control unit 230. The vector processors 210 each correspond to the vector processor 100 illustrated in FIG. 1 or the vector processor 110 illustrated in FIG. 6. The main memories 220 each correspond to the main memory 120 illustrated in FIG. 6.

For example, each vector processor 210 is a processor such as a CPU (central processing unit) and is connected to an interconnect control unit 230. Each main memory 220 is connected to a corresponding vector processor 210. The interconnect control unit 230 is connected to an external device such as a hard disk device or a communication device, and performs input and output control with respect to the external device.

When an all-set instruction for setting all the mask values of a mask register is executed, it is possible to suppress the decline in processing performance caused by the delay in execution of a subsequent instruction using a mask register.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A vector processor for executing vector arithmetic operations, comprising:
a mask register configured to hold mask values set for respective vector elements when calculation results of the vector elements are stored in a data register;
an instruction decoder configured to decode each instruction to generate instruction execution information for each decoded instruction, to set dependency information included in the instruction execution information when a decoded instruction is a subsequent instruction having data dependency with one or more previous instructions, and to set all-set information included in the instruction execution information when a decoded instruction is an all-set instruction for setting all of the mask values of the mask register;
a scheduler configured to hold the instruction execution information for each decoded instruction and to sequentially output the instruction execution information for each instruction whose data dependency has been eliminated based on the dependency information included in the held instruction execution information;
a vector processing unit configured to execute vector arithmetic operations for respective vector elements based on the instruction execution information output from the scheduler, and to store in the data register a result of an arithmetic operation of a vector element corresponding to each mask value that is in a set state and held in the mask register; and
a dependency reset unit configured to reset the dependency information corresponding to a destination operand of the subsequent instruction and the dependency information corresponding to the mask register transferred from the instruction decoder to the scheduler, when the all-set information is set for the mask register and the mask register is designated by the subsequent instruction.

2. The vector processor as claimed in claim 1, further comprising:
a first renaming map having a plurality of first entries to logical register numbers of data registers designated by instructions, the plurality of first entries being configured to hold respective physical register numbers of the data registers and dependency information; and
a second renaming map having a plurality of second entries corresponding to logical register numbers of mask registers designated by instructions, the plurality of second entries being configured to hold physical register numbers of the mask registers, dependency information, and all-set information,
wherein the dependency reset unit includes a first reset circuit configured to reset the dependency information held in one of the first entries corresponding to the destination operand of the subsequent instruction that uses as a first source operand the mask register designated by the all-set instruction, to reset the dependency information held in one of the second entries for which the all-set information is set, and to transfer all the reset dependency information to the scheduler.

3. The vector processor according to claim 2, wherein the instruction decoder is configured to set a first read signal for instructing reading of data from a merging source corresponding to the destination operand of the subsequent instruction at a time of decoding the subsequent instruction, and
wherein the dependency reset unit further includes a second reset circuit configured to reset the first read signal when the first source operand indicates the mask register designated by the all-set instruction, and to transfer the reset first read signal to the scheduler.

4. The vector processor as claimed in claim 2, wherein the instruction decoder is configured to set a second read signal for instructing reading of a mask value from the first source operand at a time of decoding the subsequent instruction, and
wherein the dependency reset unit further includes a third reset circuit configured to reset the second read signal when the first source operand indicates the mask register specified by the all-set instruction.

5. The vector processor as claimed in claim 2, wherein the dependency reset unit includes a first avoidance circuit configured to avoid resetting, and transfer to the scheduler, the dependency information stored in the first renaming map corresponding to a source operand except for the first source operand designated by the subsequent instruction when the first source operand indicates the mask register specified by the all-set instruction.

6. The vector processor as claimed in claim 2, wherein the instruction decoder is configured to set a third read signal for instructing reading of data from a data register indicated by a source operand other than the first source operand at a time of decoding the subsequent instruction, and
wherein the dependency reset unit includes a second avoidance circuit configured to avoid resetting, and transfer to the scheduler, the third read signal when the first source operand indicates the mask register designated by the all-set instruction.

7. A method of executing arithmetic operations in a vector processor which executes vector arithmetic operations, and includes a mask register configured to hold mask values set for respective vector elements when calculation results of the vector elements are stored in a data register, the method comprising:
causing an instruction decoder of the vector processor to decode each instruction to generate instruction execution information for each decoded instruction, to set dependency information included in the instruction execution information when a decoded is instruction a subsequent instruction having data dependency with one or more previous instructions, and to set all-set information included in the instruction execution information when a decoded instruction is an all-set instruction for setting all of the mask values of the mask register;
causing a scheduler of the vector processor to hold the instruction execution information for each decoded instruction and to sequentially output the instruction execution information for each instruction whose data dependency has been eliminated based on the dependency information included in the held instruction execution information;
causing a vector processing unit of the vector processor to execute vector arithmetic operations for respective vector elements based on the instruction execution information output from the scheduler, and to store in the data register a result f an arithmetic operation of a vector element corresponding to each mask value that is in a set state and held in the mask register; and
causing a dependency reset unit of the vector processor to reset the dependency information corresponding to a destination operand of the subsequent instruction and the dependency information corresponding to the mask register transferred from the instruction decoder to the scheduler, when the all-set information is set for the mask register and the mask register is designated by the subsequent instruction.
